(19) United States
(12) Patent Application Publication
(10) Pub. No.: US 2008/0004080 A1
(43) Pub. Date: Jan. 3, 2008

(54) MOBILE COMMUNICATION DEVICE AND QUICK DIALING METHOD USED THEREIN

(75) Inventors: Xiao-Guang Li, Shenzhen City (CN); Kuan-Hong Hsieh, Shenzhen City (CN)

Correspondence Address: NORTH AMERICA INTELLECTUAL PROPERTY CORPORATION, P.O. BOX 506, MERRIFIELD, VA, 22116, US

(73) Assignees: ENSKY TECHNOLOGY (SHENZHEN) CO., LTD., Shenzhen City (CN); ENSKY TECHNOLOGY CO., LTD., Taipei Hsien (CN)

(21) Appl. No.: 11/769,732

(22) Filed: Jun. 28, 2007

(30) Foreign Application Priority Data
Jun. 30, 2006 (CN) 200610061431.4

(51) Int. Cl. H04M 1/02

(52) U.S. Cl. 455/564

(57) ABSTRACT

An exemplary mobile communication device having a quick dialing function is provided. The device includes a display, a hot key, a storage unit, a processing unit, and a plurality of alphanumeric keys. The storage unit is configured for storing inbound call information and outbound call information. The processing unit is programmed for displaying a subset of a communication list on the display in response to a signal generated from the hot key, wherein the communication list consists of communication records that are derived from the inbound call information and outbound call information. Each of the alphanumeric keys corresponds to one of the displayed communication records, and when actuated, signals the mobile communication device to contact one of the communication records whose display order is identical with a numeral indicated by the actuated alphanumeric key. A quick dialing method adapted for the mobile communication device is also provided.

### BACKGROUND

1. Technical Field

The present invention relates to mobile communication devices, and particularly to a mobile communication device and a method capable of quickly dialing a desired telephone number in a simple and effective manner.

2. General Background

In a mobile communication device (e.g., a mobile phone), it is time consuming for a user who frequently calls a certain party to dial all the digits of the certain party's telephone number each time a call is placed. To solve this inefficiency, mobile phones have been provided with a phone book function for storing frequently used telephone numbers. When dialing a telephone number using the phone book function, the user presses a function key and a scroll key one or more times to retrieve the desired telephone number. Once the desired telephone number is retrieved, the number can be dialed automatically by means of another key entered by the user. This phone book function is useful for the purpose of dialing a telephone number that the user cannot remember. However, the speed by which the number can be dialed from the start of the process is limited, since the user still may have to press the keys repeatedly to scroll down a list until the desired telephone number is retrieved. It may even happen that, the user may press the keys more times than the number of the digits of the telephone number.

In another approach, mobile phones have been provided with a speed dial function for registering frequently used telephone numbers in association with unique hot keys (generally digit buttons). The user can dial the registered telephone numbers by pressing the associated hot keys, but needs to remember the telephone number or party associated with the respective hot keys. Accordingly, the user typically needs to separately note the telephone numbers or parties associated with the respective hot keys, which is cumbersome. Further, when the mobile phone stores a plurality of telephone numbers, the hot keys may be limited and does not meet all the stored telephone numbers.

Another technique that has been introduced to facilitate dialing has been to equip the mobile phone with a history telephone number list and a redial key to implement a redial function. The redial key, as well known, is used to redial the last telephone number dialed. The history telephone number list has a limited storage for storing the telephone numbers communicated (e.g., dialed or answered) recently. The telephone numbers are listed according to the temporal order they have been communicated, typically, the most recent one will be listed in front of all others. Consequently, when the users want to dial a particular telephone number, recently dialed or answered, they may have to spend more time retrieving the desired telephone number from the history telephone number list. In addition, some of the telephone numbers listed may repeatedly appear when they are dialed more times. As a result, some frequently telephone numbers may be replaced by the repetitive telephone numbers.

What is needed, therefore, is a mobile communication device and a method used therein that applies an improved dialing mechanism, so that the users can quickly and easily obtain the desired telephone number, and dial the desired telephone number in a simple and effective manner.

### SUMMARY

A mobile communication device with a quick dialing function is provided. The device includes a display, a hot key, a storage unit, a processing unit, and a plurality of alphanumeric keys. The storage unit is configured for storing inbound call information and outbound call information. The processing unit is programmed for displaying a subset of a communication list on the display in response to a signal generated from the hot key, wherein the communication list consists of communication records which are derived from the inbound call information and outbound call information. Each of the alphanumeric keys corresponds to one of the displayed communication records, and when pressed, signals the mobile communication device to contact one of the displayed communication records whose display order is identical with a numeral indicated by the pressed alphanumeric key.

A quick dialing method adapted for a mobile communication device is also provided. The mobile communication device includes a display, a hot key, and a storage unit for storing inbound call information and outbound call information. The inbound call information and outbound call information includes a directory and a communication history list, wherein the directory has a plurality of group, and the communication history list records previous communication records and frequencies of communication of each of the previous communication records. The method includes: (a) displaying a subset of a communication list on the display in response to a signal generated from the hot key while the display has no communication list thereon and the mobile communication device is not in a message edit state, wherein the communication list consists of communication records which are derived from the inbound call information and outbound call information; (b) providing a plurality of alphanumeric keys, each of which corresponds to one of the displayed communication records; and (c) signaling the mobile communication device to contact one of the displayed communication records whose display order is identical with a numeral indicated by the actuated alphanumeric key, when one of the alphanumeric keys is actuated.

Other advantages and novel features will be drawn from the following detailed description with reference to the attached drawing.

### BRIEF DESCRIPTION OF THE DRAWINGS

FIG. 1 is a schematic diagram of a hardware infrastructure of a mobile communication device in accordance with a preferred embodiment of the present invention;

FIG. 2 is a schematic diagram of a front view of the mobile communication device of FIG. 1 in accordance with a preferred embodiment of the present invention;

FIG. 3 is a schematic diagram of a front view of the mobile communication device of FIG. 1 in accordance with another preferred embodiment of the present invention;

FIG. 4 is a schematic diagram illustrating the mobile communication device of FIG. 1 displays a communication list in response to a signal generated from a hot key in accordance with a first preferred embodiment of the present invention;

FIG. 5 is a schematic diagram illustrating the mobile communication device of FIG. 1 displays a communication list in response to a signal generated from a hot key in accordance with a second preferred embodiment of the present invention;

FIG. 6 is a schematic diagram illustrating the mobile communication device of FIG. 1 displays a communication list in response to a signal generated from a hot key in accordance with a third preferred embodiment of the present invention;

FIG. 7 is a schematic diagram illustrating the mobile communication device of FIG. 4 further displays a string of numerals beside of the communication list; and

FIG. 8 is a flowchart of a quick dialing method adapted for the mobile communication device of FIG. 1 in accordance with a preferred embodiment of the present invention.

### DETAILED DESCRIPTION OF THE EMBODIMENT

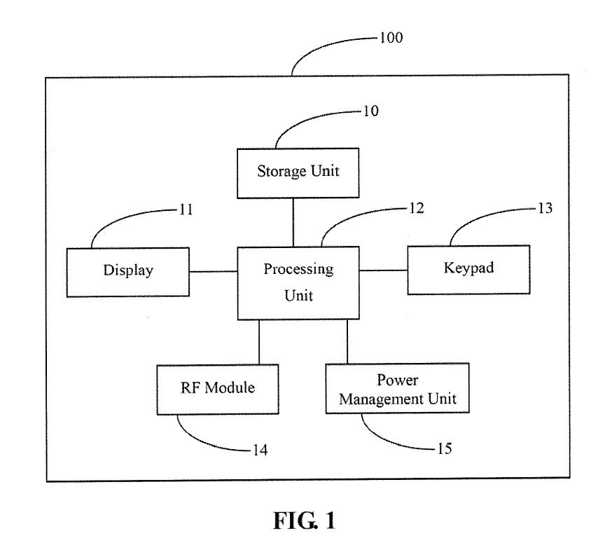

FIG. 1 is a schematic diagram of a hardware infrastructure of a mobile communication device in accordance with a preferred embodiment of the present invention. The mobile communication device 100 includes a storage unit 10, a display 11, a processing unit 12, a keypad 13, a Radio Frequency (RF) module 14, and a power management unit 15. The power management unit 15 is configured for managing power supply from a battery (not shown). The RF module 14 is configured for modulating and converting frequency of data received from the processing unit 12 thus to obtain a radio signal, and sending the radio signal through an antenna (not shown). The RF module 14 is also configured for separating a signal received from the antenna and feeding it after frequency conversion and demodulation. The display 11 is configured for displaying information.

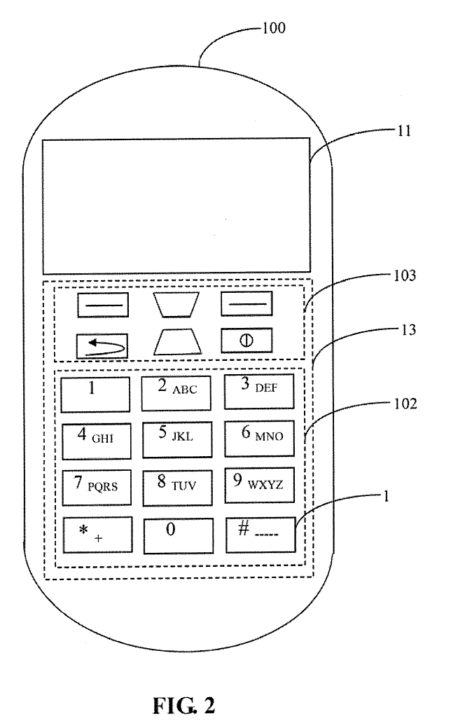

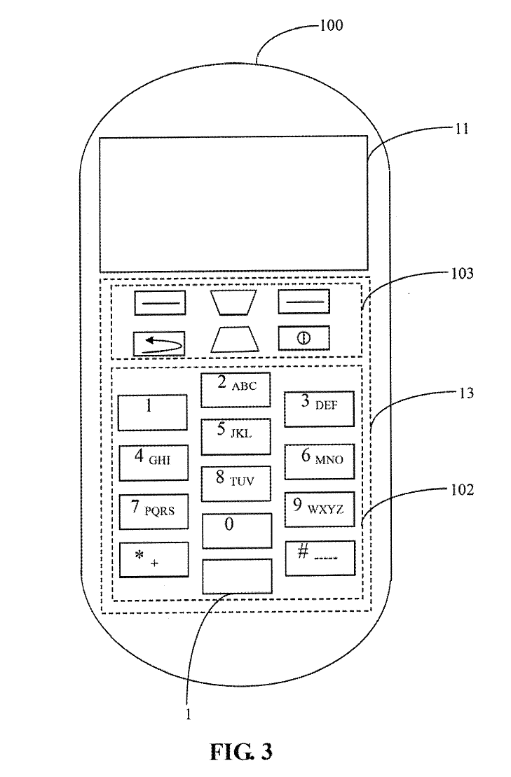

The keypad 13 is configured for receiving operational inputs. Referring to FIGS. 2 and 3, the keypad 13 has a first section 102 and a second section 103 shown as dashed line respectively. The second section 103 includes a plurality of function keys arranged in a matrix manner, in the preferred embodiment the matrix manner is configured with three columns and two rows. The first section 102 includes a plurality of alphanumeric keys and a hot key 1. The hot key 1 can be selected from the alphanumeric keys such as that shown in FIG. 2, or can be an additional key other than the alphanumeric keys such as that shown in FIG. 3.

The storage unit 10 is configured for storing inbound call information and outbound call information, which are grouped into a communication history list and a contact list. The communication history list is configured for recording previous communication records and frequencies of communication of each of the previous communication record. Each of the previous communication records may include, for example, a telephone number, an identification, a time of the communication, and a length of a communication time. The contact list is configured for recording contact records. Each of the contact records may include, for example, such as, a telephone number, a name, an address, and the like. In addition, the contact records of the contact list can be categorized into a plurality of groups according to users' preference, such as, for example, a family group, a friend group, a colleague group, etc.

The processing unit 12 is electrically connected with the storage unit 10, display 11, keypad 13, RF module 14, and the power management unit 15, and is configured for controlling operations of these aforementioned components according to signals generated after the operational inputs on the keys of the keypad 13 and a current state of the mobile communication device 100.

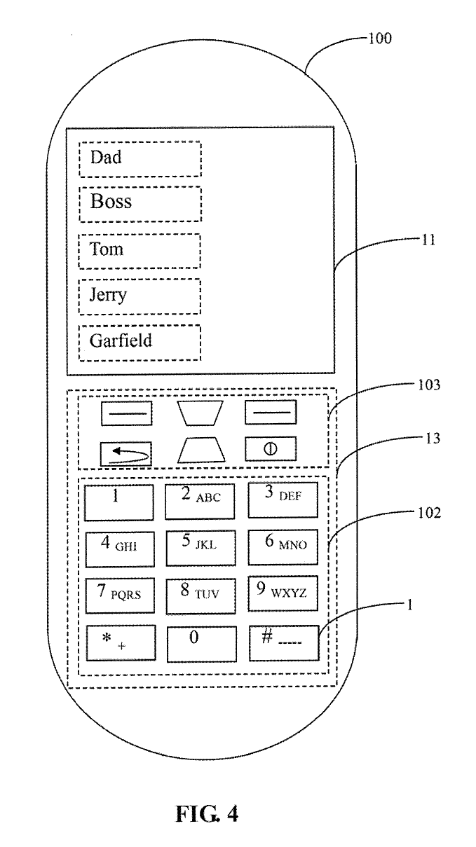

When the processing unit 12 receives the signal generated from the hot key 1 while no communication list is on the display 11 and the mobile communication device 100 is not in a message edit state, the processing unit 12 generates a communication list derived from the inbound call information and outbound call information, and displays a subset of the communication list on the display 11. Wherein, a size of the subset is dependent on a size of the display 11. In other words, a greater the size of the display 11, a greater number of the records is shown on the display 11. For simplicity, in the embodiments described below, the display 11 is able to show 5 records. Typically, the processing unit 12 only displays partial information of the communication list on the display 11. For example, in the embodiments as shown in FIGS. 4-6, the processing unit 12 only displays names of the caller or callee. In addition, the communication list may be derived based on different parts of the inbound call information and outbound call information.

For example, in a first preferred embodiment, the communication list is derived from the communication history list. That is, the communication list consists of the previous communication records that are listed in a descending order according to the associated frequencies of communication of each of the previous communication records, such as that shown in FIG. 4.

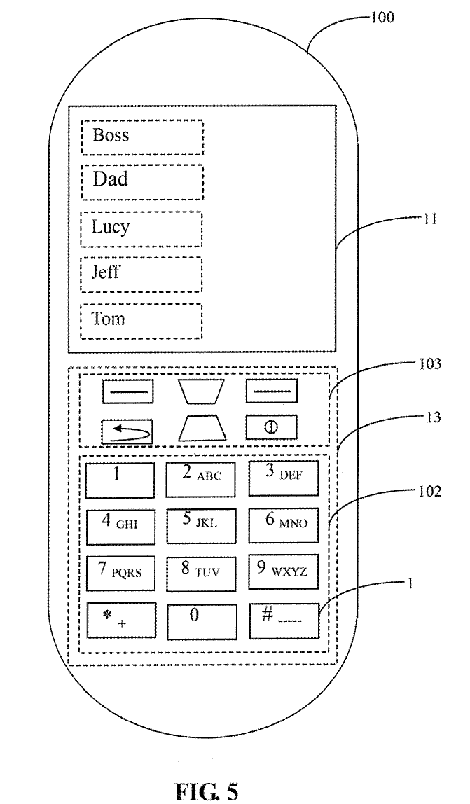

In a second preferred embodiment, the communication list is derived from the communication history list. That is, the communication list consists of the previous communication records that are communicated in a most recent period, such as that shown in FIG. 5. The most recent period can be a constant time period or any configurable predetermined time period.

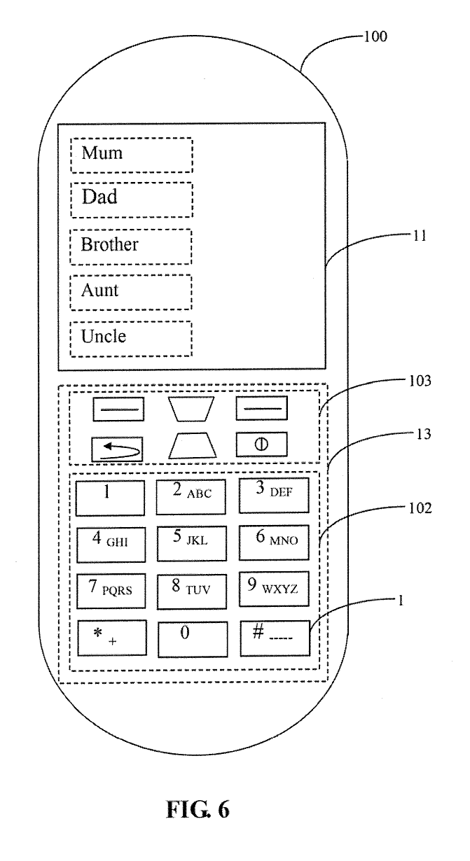

In a third preferred embodiment, the communication list is derived from the contact list. That is, the communication list consists of the contact records that are listed according to configurable predefined groups. For example, the processing unit 12 displays the contact list in a particular group order, such as, the family group, the friend group, and the colleague group. Accordingly, such as that shown in FIG. 6, the processing unit 12 displays the subset of the family group first, e.g., “Mum”, “Dad”, “Brother”, “Aunt”, “Uncle”, in response to the signal generated from the hot key 1.

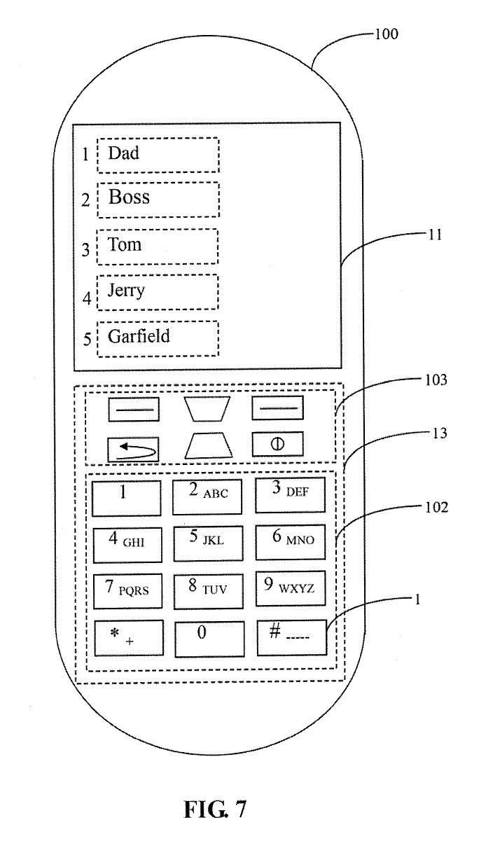

Furthermore, while displaying the communication list on the display 11, the processing unit 12 also can display a string of numerals beside the displayed records, such as that shown in FIG. 7. The numerals are used for performing a speed dialing function. That is, to actuate a corresponding alphanumeric key having a same numeral to contact a corresponding displayed record. For example, when the alphanumeric key “2” is actuated, the mobile communication device 100 contacts the “Boss” correspondingly.

Corresponding to the displayed records, the mobile communication device 100 provides an equal number (e.g., 5) of alphanumeric keys (e.g., alphanumeric key 1 to alphanumeric key 5) as speed dial keys for signaling the mobile communication device 100 to contact the corresponding displayed record whose display order is identical with the numeral indicated by the speed dial key when actuated. In addition, in the case when the hot key 1 is one of the alphanumeric keys such as that shown in FIG. 2, the hot key 1 selected, is typically one of the alphanumeric keys whose numeral does not fall into a number of the displayed records. Accordingly, the hot key 1 is selected from the alphanumeric keys whose numeral does not fall into the number from 1 to 5.

When the processing unit 12 receives the signal while the communication list is on the display 11, the processing unit 12 determines which key generates the signal. If the signal is generated from one of the speed dial keys (i.e., the alphanumeric keys from 1 to 5), the mobile communication device 100 contacts the corresponding displayed record whose display order is identical with the numeral indicated by the actuated alphanumeric key. If the signal is generated from the hot key 1, the processing unit 12 displays a next subset of the communication list on the display 11. If the signal is generated from other alphanumeric keys other than the alphanumeric keys 1 to 5, the processing unit 12 does not process the signal. If the signal is generated from one of the function keys, the processing unit 12 performs an operation corresponding to the actuated function key.

Moreover, while the display 11 is a non-volatile display, such as an E-ink (Electronic Ink) display having a property of being able to display information without power, the processing unit 12 further generates a power off signal to the power management unit 13 for powering off the display 11 after displaying the subset of the communication list on the E-ink display 11. The property of the E-ink display 11 would allow the mobile communication device 100 to readily display the subset of the communication list on the E-ink display 11 without consuming power, and thus to save power consumption of the mobile communication device 100.

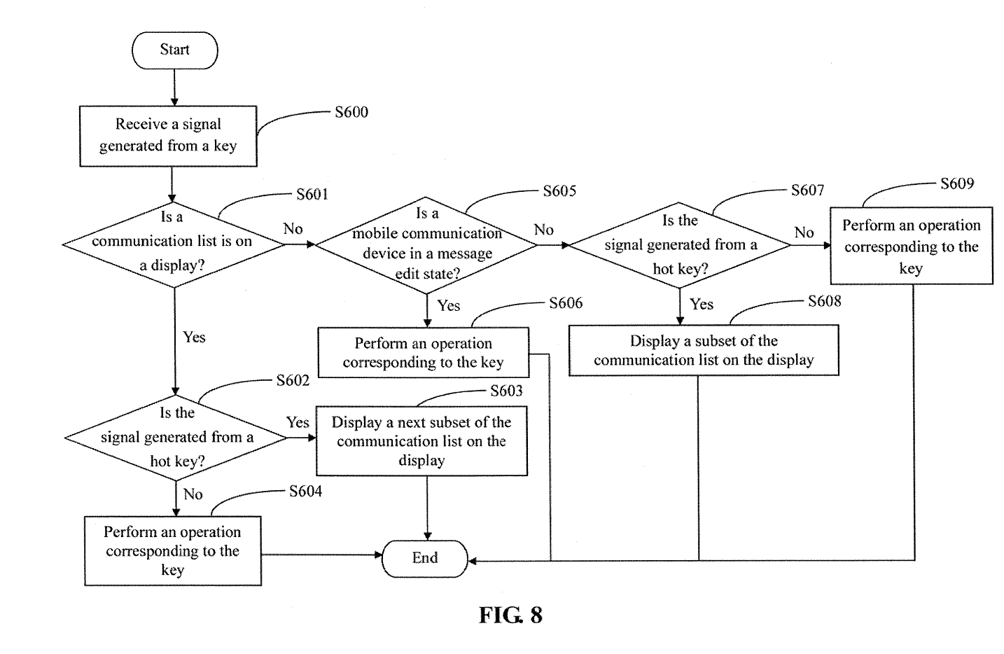

FIG. 8 is a flowchart of a quick dialing method adapted for the mobile communication device 100 in accordance with a preferred embodiment of the present invention.

In step S600, the processing unit 12 receives the signal generated from the keys of the keypad 13.

In step S601, the processing unit 12 determines whether the communication list is already on the display 11. If the communication list is not on the display 11, the procedure goes to step S605 described below.

If the communication list is already on the display 11, in step S602, the processing unit 12 determines whether the signal is generated from the hot key 1.

If the signal is generated from the hot key 1, in step S603, the processing unit displays a next subset of the communication list on the display 11.

Otherwise, in step S604, the processing unit 12 performs an operation corresponding to the key. Typically, while the signal is generated from the speed dial key, the processing unit 12 signals the mobile communication device 100 to contact the corresponding record.

In step S605, the processing unit 12 determines whether the mobile communication device 100 is in the message edit state.

If the mobile communication device 100 is in the message edit state, in step S606, the processing unit 12 performs an operation corresponding to the key in the message edit state, and the procedure is finished.

Otherwise, in step S607, the processing unit 12 determines whether the signal is generated from the hot key 1.

If the signal is generated from the hot key 1, in step S608, the processing unit 12 displays the subset of the communication list on the display 11 and the procedure is finished.

Otherwise, in step S609, the processing unit 12 performs an operation corresponding to the key, and the procedure is finished.

Although the present invention has been specifically described on the basis of preferred embodiments including a preferred method thereof, the invention is not to be construed as being limited thereto. Various changes or modifications may be made to the embodiments including the method without departing from the scope and spirit of the invention.

What is claimed is:

1. A mobile communication device with a quick dialing function, comprising:
a display;
a hot key;
a storage unit for storing inbound call information and outbound call information;
a processing unit, programmed for displaying a subset of a communication list on the display in response to a signal generated from the hot key, wherein the communication list consists of communication records which are derived from the inbound call information and outbound call information; and
a plurality of alphanumeric keys, each of which corresponds to one of the displayed communication records, and when actuated, signals the mobile communication device to contact one of the displayed communication records whose display order is identical with a numeral indicated by the actuated alphanumeric key.

2. The mobile communication device according to claim 1, wherein the inbound call information and outbound call information comprise a directory and a communication history list, wherein the communication history list records previous communication records and frequencies of communication of each of the previous communication records.

3. The mobile communication device according to claim 2, wherein the processing unit displays a subset of the directory on the display in response to the signal generated from the hot key.

4. The mobile communication device according to claim 3, wherein the directory has a plurality of groups, and the processing unit displays the subset of the directory based on the groups.

5. The mobile communication device according to claim 2, wherein the processing unit displays a subset of the previous communication records of the communication history list on the display in response to the signal generated from the hot key, wherein the displayed previous communication records are listed orderly according to associated frequencies of communication of the previous communication records.

6. The mobile communication device according to claim 2, when the subset of the communication list is on display and the processing unit receives a new signal generated from the hot key, the processing unit displays a next subset of the communication list in response to the new signal generated from the hot key.

7. The mobile communication device according to claim 6, wherein the display is a non-volatile display, and the processing unit generates a signal for powering off the non-volatile display after the subset of the communication list is displayed on the non-volatile display.

8. The mobile communication device according to claim 2, wherein the hot key is selected from one of the alphanumeric keys other than the alphanumeric keys correspond to the displayed communication records.

9. A quick dialing method adapted for a mobile communication device, which comprises a display, a hot key, and a storage unit for storing inbound call information and outbound call information, wherein the inbound call information and outbound call information comprise a directory and a communication history list, wherein the directory has a plurality of groups, and the communication history list records previous communication records and frequencies of communication of each of the previous communication records, the method comprising:
displaying a subset of a communication list on the display in response to a signal generated from the hot key while the display has no communication list thereon and the mobile communication device is not in a message edit state, wherein the communication list consists of communication records which are derived from the inbound call information and outbound call information;
providing a plurality of alphanumeric keys, each of which corresponds to one of the displayed communication records; and
signaling the mobile communication device to contact one of the displayed communication records whose display order is identical with a numeral indicated by the actuated alphanumeric key, when one of the alphanumeric keys is actuated.

10. The method according to claim 9, further comprising:
displaying a next subset of the communication list on the display in response to a new signal generated from the hot key while the subset of the communication list is on the display.

11. The method according to claim 10, wherein the displaying of a subset of a communication list further comprises:
displaying a subset of the directory based on the groups on the display in response to the signal generated from the hot key.

12. The method according to claim 10, wherein the displaying of a subset of a communication list further comprises:
displaying a subset of the previous communication records of the communication history list on the display in response to the signal generated from the hot key, wherein the display previous communication records are listed orderly according to associated frequencies of communication of the previous communication records.
